(19) United States
(12) Patent Application Publication
(10) Pub. No.: US 2024/0145161 A1
(43) Pub. Date: May 2, 2024

(54) INDUCTOR COMPONENT

(71) Applicant: Murata Manufacturing Co., Ltd., Kyoto-fu (JP)

(72) Inventors: Kenji TOYOSHIMA, Nagaokakyo-shi (JP); Yoshimasa YOSHIOKA, Nagaokakyo-shi (JP)

(73) Assignee: Murata Manufacturing Co., Ltd., Kyoto-fu (JP)

(21) Appl. No.: 18/469,677

(22) Filed: Sep. 19, 2023

(30) Foreign Application Priority Data
Oct. 28, 2022 (JP) 2022-173537

(51) Int. Cl. H01F 27/29; H01F 27/28; H01F 27/34

(52) U.S. Cl. CPC H01F 27/292; H01F 27/2823; H01F 27/34; H01F 2027/348

(57) ABSTRACT

An inductor component includes an element body, an inductor wire, and a plurality of columnar wires. The element body has a first principal surface. The inductor wire extends parallel to the first principal surface within the element body. Each columnar wire is connected to an end of the inductor wire and extends in a direction orthogonal to the first principal surface. The plurality of columnar wires are exposed from the element body at the first principal surface. A minimum distance from the first principal surface to the inductor wire is larger than or equal to 0.04 mm.

### CROSS-REFERENCE TO RELATED APPLICATION

This application claims benefit of priority to Japanese Patent Application No. 2022-173537, filed Oct. 28, 2022, the entire content of which is incorporated herein by reference.

### BACKGROUND

### Technical Field

The present disclosure relates to inductor components.

### Background Art

An inductor component described in Japanese Unexamined Patent Application Publication No. 2019-075537 includes an element body, three inductor wires, and six outer electrodes. The element body has a rectangular parallelepiped shape with principal surfaces. The element body has four end surfaces that are adjacent to the principal surfaces. Each inductor wire extends spirally. Each inductor wire is connected to a pair of outer electrodes. Two outer electrodes are provided for each inductor wire. Specifically, the inductor component has three sets of outer electrodes. The outer electrodes are exposed at the end surfaces of the element body.

### SUMMARY

In the inductor component described in Japanese Unexamined Patent Application Publication No. 2019-075537, the outer electrodes are exposed at the end surfaces. When the outer electrodes are disposed in this manner, solder also exists on the end surfaces of the element body when the inductor component is to be mounted on a substrate. Therefore, when this inductor component is mounted on the substrate, the installation space increases. On the other hand, for example, it is conceivable that the outer electrodes be disposed so as to be exposed only at the principal surfaces. In this case, however, magnetic flux occurring when electric current is applied to the inductor wires penetrates the outer electrodes and terminals on the substrate, possibly leading to an increase in loss occurring due to an eddy current.

Accordingly, the present disclosure provides an inductor component including an element body having a principal surface; an inductor wire extending parallel to the principal surface within the element body; and a plurality of columnar wires connected to an end of the inductor wire and extending in a direction intersecting the principal surface. The plurality of columnar wires are exposed from the element body at the principal surface. A minimum distance from the principal surface to the inductor wire is larger than or equal to 0.04 mm.

In the above configuration, magnetic flux occurring when electric current is applied to the inductor wire can be prevented from penetrating an outer electrode and a terminal on a substrate. Accordingly, with this configuration, an eddy current loss can be suppressed when the electric current is applied to the inductor wire.

An eddy current loss can be suppressed when electric current is applied to the inductor wire.

### BRIEF DESCRIPTION OF THE DRAWINGS

FIG. 1 is a perspective view of an inductor component;

FIG. 2 is a plan view of the inductor component;

FIG. 3 is a cross-sectional view taken along line 3-3 in FIG. 2;

FIG. 4 is a plan view of an inductor component according to a modification;

FIG. 5 illustrates a Q-value obtained in a simulation;

FIG. 6 illustrates a gradient of the Q-value obtained in the simulation;

FIG. 7 illustrates a Q-value obtained in a simulation according to a modification;

FIG. 8 illustrates a gradient of the Q-value obtained in the simulation according to the modification;

FIG. 9 is a plan view of an inductor component according to a modification;

FIG. 10 is a plan view of an inductor component according to a modification;

FIG. 11 is a perspective view of an inductor component according to a modification; and

FIG. 12 is a plan view of the inductor component according to the modification illustrated in FIG. 11.

### DETAILED DESCRIPTION

An inductor component according to an embodiment will be described below. The drawings may sometimes be illustrated with the elements being enlarged for facilitating the understanding of the drawings. The dimensional ratios of the elements may sometimes be different from the actual elements or from those in other drawings.

Overall Configuration

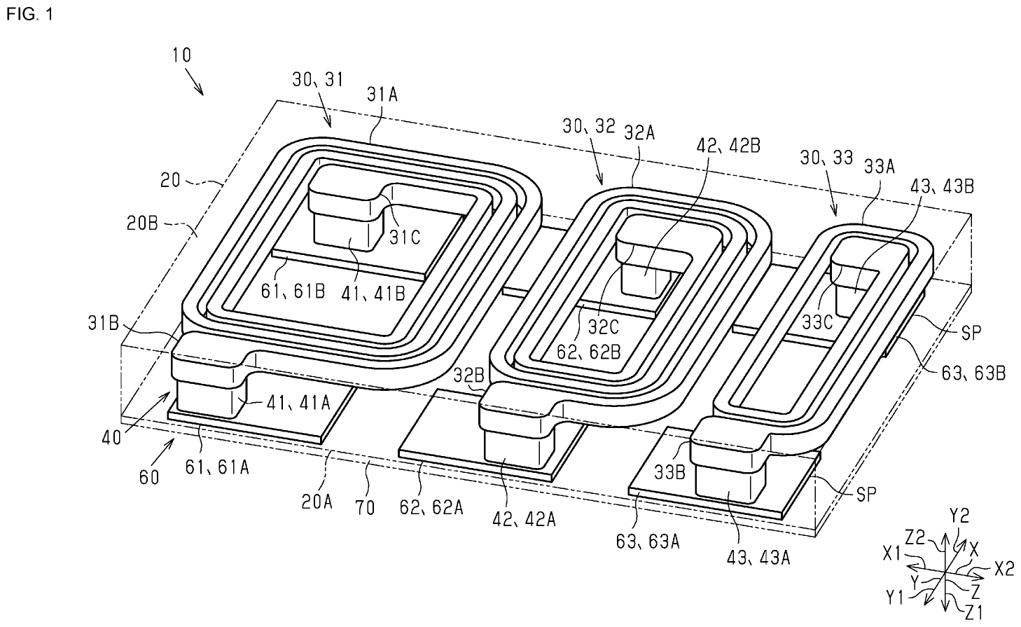

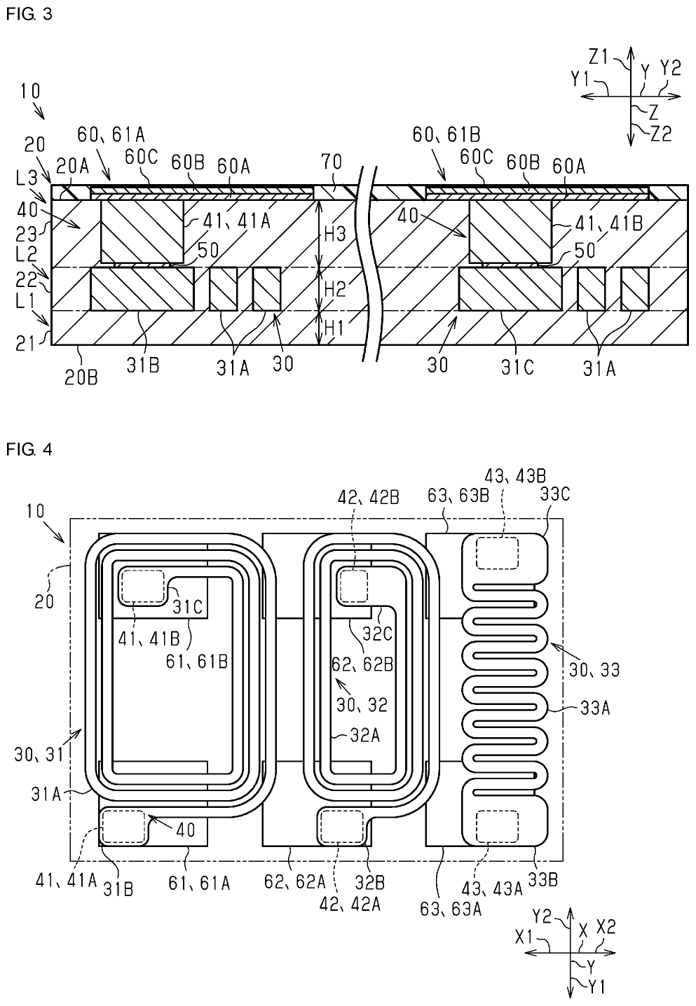

As illustrated in FIG. 1, an inductor component 10 includes an element body 20, a plurality of inductor wires 30, a plurality of columnar wires 40, and a plurality of outer electrodes 60. As illustrated in FIG. 3, the inductor component 10 also includes a plurality of vias 50.

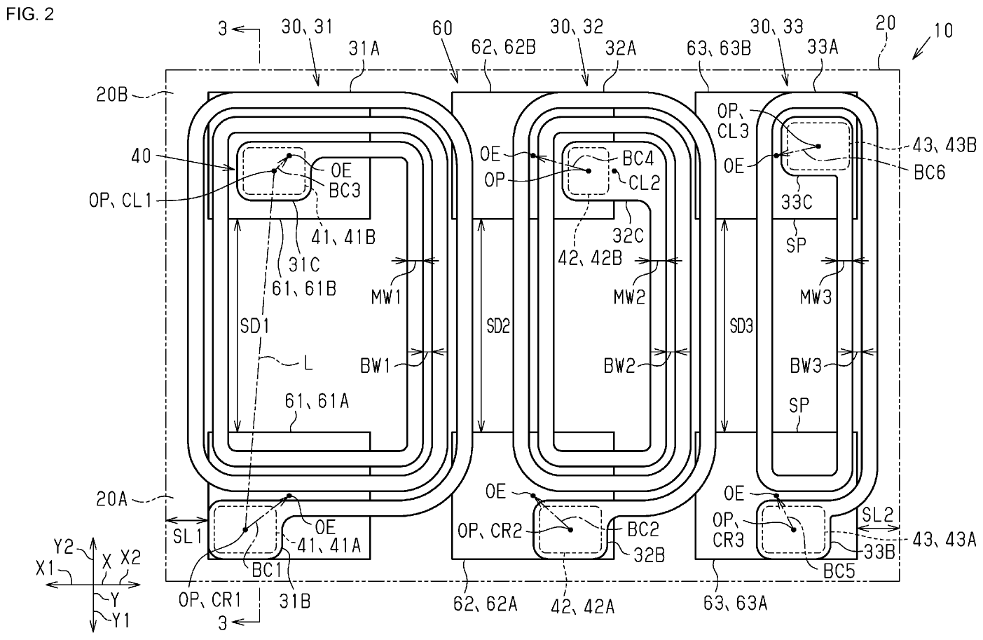

As illustrated in FIG. 1, the element body 20 entirely has a rectangular parallelepiped shape. Specifically, the element body 20 has six outer surfaces. Of these six outer surfaces, one of the two largest outer surfaces will be defined as a first principal surface 20A. Of the six outer surfaces, a surface parallel to the first principal surface 20A will be defined as a second principal surface 20B. Specifically, when viewed in a direction orthogonal to the first principal surface 20A, the first principal surface 20A and the second principal surface 20B are quadrilateral. In detail, the first principal surface 20A and the second principal surface 20B are rectangular. The first principal surface 20A serves as a mounting surface facing a substrate when the inductor component 10 is to be mounted on the substrate. In FIG. 1 and FIG. 2, the element body 20 is indicated with a double-dashed chain line. The element body 20 is composed of, for example, a photosensitive resin material, polyimide, a ceramic material, glass, or Si.

In the following description, an axis parallel to the long sides of the first principal surface 20A will be defined as a first axis X. Specifically, the first axis X is parallel to edges of the first principal surface 20A. An axis parallel to the short sides of the first principal surface 20A will be defined as a second axis Y. Furthermore, an axis orthogonal to the first principal surface 20A will be defined as a third axis Z. Of directions extending along the first axis X, a specific direction will be defined as a first positive direction X1, and a direction opposite the first positive direction X1 will be defined as a first negative direction X2. Of directions extending along the second axis Y, a specific direction will be defined as a second positive direction Y1, and a direction opposite the second positive direction Y1 will be defined as a second negative direction Y2. Furthermore, of directions extending along the third axis Z, a direction in which the first principal surface 20A is oriented will be defined as a third positive direction Z1, and a direction opposite the third positive direction Z1 will be defined as a third negative direction Z2.

As illustrated in FIG. 3, the element body 20 includes a first layer L1, a second layer L2, and a third layer L3. The maximum dimension of the element body 20 in the direction extending along the third axis Z is about 0.13 mm. Specifically, a total value of the thickness of the first layer L1, the thickness of the second layer L2, and the thickness of the third layer L3 is about 0.13 mm. In other words, the maximum dimension of the element body 20 in the direction extending along the third axis Z is smaller than or equal to 0.15 mm.

When viewed transparently in the direction extending along the third axis Z, the first layer L1 is rectangular. The first layer L1 is disposed at an end located toward the third negative direction Z2 of the element body 20. In other words, an end surface of the first layer L1 in the third negative direction Z2 is the second principal surface 20B. The first layer L1 includes a first element body layer 21.

When viewed transparently in the direction extending along the third axis Z, the second layer L2 is rectangular, similar to the first layer L1. The second layer L2 is laminated on the surface located toward the third positive direction Z1 of the first layer L1. The second layer L2 has a second element body layer 22 and three inductor wires 30. In the second layer L2, a portion excluding the three inductor wires 30 serves as the second element body layer 22. The shape and the arrangement of the inductor wires 30 will be described later.

When viewed transparently in the direction extending along the third axis Z, the third layer L3 is rectangular, similar to the first layer L1 and the second layer L2. The third layer L3 is laminated on the surface located toward the third positive direction Z1 of the second layer L2. The third layer L3 has a third element body layer 23, six columnar wires 40, and six vias 50. In the third layer L3, a portion excluding the six columnar wires 40 and the six vias 50 serves as the third element body layer 23. The shape and the arrangement of the columnar wires 40 and the vias 50 will be described later.

In FIG. 3, boundaries among the first layer L1 to the third layer L3 are imaginarily indicated with single-dot chain lines. On the other hand, the first element body layer 21, the second element body layer 22, and the third element body layer 23 that neighbor each other may sometimes be integrated. In other words, the first element body layer 21, the second element body layer 22, and the third element body layer 23 that neighbor each other do not have to be separated by clear boundaries.

Thickness of Each Layer of Element Body

As illustrated in FIG. 3, a dimension H1 of the first layer L1 in the direction extending along the third axis Z is 0.02 mm. A dimension H2 of the second layer L2 in the direction extending along the third axis Z is 0.04 mm. A dimension H3 of the third layer L3 in the direction extending along the third axis Z is 0.07 mm. Specifically, the minimum distance from the first principal surface 20A to the inductor wires 30 is larger than or equal to 0.04 mm. Furthermore, the minimum distance from the first principal surface 20A to the inductor wires 30 is larger than or equal to twice the minimum distance from the second principal surface 20B to the inductor wires 30.

Inductor Wires

Each inductor wire 30 is composed of a conductive material. For example, each inductor wire 30 contains at least one of Cu, Ag, Au, Ni, and Al as a conductive material. Moreover, for example, each inductor wire 30 may include an alloy containing at least two of Cu, Ag, Au, Ni, and Al as a conductive material.

As illustrated in FIG. 1, the three inductor wires 30 are a first inductor wire 31, a second inductor wire 32, and a third inductor wire 33.

As illustrated in FIG. 3, the first inductor wire 31 extends parallel to the first principal surface 20A within the element body 20. In detail, the first inductor wire 31 extends on the surface located toward the third positive direction Z1 of the first layer L1. Furthermore, the first inductor wire 31 has a wire body 31A, a first end pad 31B, and a second end pad 31C.

As illustrated in FIG. 2, when viewed transparently in the direction orthogonal to the first principal surface 20A, the wire body 31A of the first inductor wire 31 extends spirally. Of ends of the wire body 31A of the first inductor wire 31, an end located toward the second positive direction Y1 relative to the geometric center of the element body 20 will be defined as a first end. Furthermore, of the ends of the wire body 31A of the first inductor wire 31, an end located toward the second negative direction Y2 relative to the geometric center of the element body 20 will be defined as a second end.

When viewed transparently in the direction orthogonal to the first principal surface 20A, the wire body 31A of the first inductor wire 31 has a spiral shape that decreases in diameter from the first end toward the second end.

A wire width MW1 of the wire body 31A of the first inductor wire 31 is fixed. The wire width MW1 is a dimension in a direction parallel to the first principal surface 20A and orthogonal to the extending direction of the wire body 31A of the first inductor wire 31.

A distance BW1 between wire segments of the wire body 31A of the first inductor wire 31 is larger than or equal to ⅓ of the wire width MW1 of the first inductor wire 31. Specifically, the minimum distance between wire segments of the first inductor wire 31 is larger than or equal to ⅓ of the minimum wire width of the first inductor wire 31. The distance BW1 between wire segments of the wire body 31A is substantially fixed over the entire range. The distance BW1 between wire segments of the wire body 31A of the first inductor wire 31 is the distance between wire segments of the wire body 31A in the direction orthogonal to the extending direction of the wire body 31A.

The first end pad 31B of the first inductor wire 31 is connected to the first end of the wire body 31A. When viewed transparently in the direction orthogonal to the first principal surface 20A, the first end pad 31B of the first inductor wire 31 has a substantially rectangular shape with the long sides thereof extending along the first axis X. When viewed transparently in the direction orthogonal to the first principal surface 20A, the first end pad 31B of the first inductor wire 31 has a wire width larger than the wire width MW1 of the wire body 31A. When viewed transparently in the direction orthogonal to the third axis Z, the wire width of the first end pad 31B is the dimension of the first end pad 31B in the direction orthogonal to the extending direction of the wire body 31A at the connection area between the first end pad 31B and the wire body 31A. Specifically, the wire width of the first end pad 31B of the first inductor wire 31 is the dimension in a direction extending along the second axis Y. As illustrated in FIG. 3, the first end pad 31B of the first inductor wire 31 is connected to the corresponding columnar wire 40 with the corresponding via 50 interposed therebetween.

As illustrated in FIG. 2, the second end pad 31C of the first inductor wire 31 is connected to the second end of the wire body 31A. When viewed transparently in the direction orthogonal to the first principal surface 20A, the second end pad 31C of the first inductor wire 31 has a substantially rectangular shape with the long sides thereof extending along the first axis X. When viewed transparently in the direction orthogonal to the first principal surface 20A, the second end pad 31C of the first inductor wire 31 has a wire width larger than the wire width MW1 of the wire body 31A. The wire width of the second end pad 31C of the first inductor wire 31 is the dimension in the direction extending along the second axis Y. As illustrated in FIG. 3, the second end pad 31C of the first inductor wire 31 is connected to the corresponding columnar wire 40 with the corresponding via 50 interposed therebetween.

The number of turns in the first inductor wire 31 is 2.5. The number of turns in the first inductor wire 31 is the total number of turns from the outer peripheral edge of the first end pad 31B to the outer peripheral edge of the second end pad 31C via the outer peripheral edge of the wire body 31A.

The number of turns in each inductor wire 30 is set based on an imaginary vector. A starting point of the imaginary vector is disposed on an imaginary line extending in the extending direction of the inductor wire 30 through any edge of the wire width of the inductor wire 30 including a pad. When viewed in the direction extending along the third axis Z, the imaginary vector is in contact with the imaginary line extending in the extending direction of the inductor wire 30.

When the starting point of the imaginary vector is moved from one end of the imaginary line to the other end of the imaginary line, the number of turns is set to “1.0 turns” when the angle by which the imaginary vector has rotated is “360°”. Therefore, when the imaginary vector is rotated by, for example, “180°”, the number of turns is “0.5 turns”.

As illustrated in FIG. 1, the second inductor wire 32 extends parallel to the first principal surface 20A within the element body 20. The configuration of the second inductor wire 32 is similar to the configuration of the first inductor wire 31. In detail, the second inductor wire 32 extends on the surface located toward the third positive direction Z1 of the first layer L1. Specifically, the second inductor wire 32 extends in the same plane as the first inductor wire 31. The second inductor wire 32 is located toward the first negative direction X2 with reference to the first inductor wire 31. The second inductor wire 32 has a wire body 32A, a first end pad 32B, and a second end pad 32C.

As illustrated in FIG. 2, when viewed transparently in the direction orthogonal to the first principal surface 20A, the wire body 32A of the second inductor wire 32 extends spirally. Of ends of the wire body 32A of the second inductor wire 32, an end located toward the second positive direction Y1 relative to the geometric center of the element body 20 will be defined as a first end. Furthermore, of the ends of the wire body 32A of the second inductor wire 32, an end located toward the second negative direction Y2 relative to the geometric center of the element body 20 will be defined as a second end.

When viewed transparently in the direction orthogonal to the first principal surface 20A, the wire body 32A of the second inductor wire 32 has a spiral shape that decreases in diameter from the first end toward the second end. The wire body 32A of the second inductor wire 32 extends spirally in the same direction as the wire body 31A of the first inductor wire 31.

A wire width MW2 of the wire body 32A of the second inductor wire 32 is fixed. The wire width MW2 is a dimension in a direction parallel to the first principal surface 20A and orthogonal to the extending direction of the wire body 32A of the second inductor wire 32. The wire width MW2 of the wire body 32A of the second inductor wire 32 is equal to the wire width MW1 of the wire body 31A of the first inductor wire 31.

A distance BW2 between wire segments of the wire body 32A of the second inductor wire 32 is larger than or equal to ⅓ of the wire width MW2 of the second inductor wire 32. Specifically, the minimum distance between wire segments of the second inductor wire 32 is larger than or equal to ⅓ of the minimum wire width of the second inductor wire 32. The distance BW2 between wire segments of the wire body 32A is substantially fixed over the entire range. The distance BW2 between wire segments of the wire body 32A of the second inductor wire 32 is the distance between wire segments of the wire body 32A in the direction orthogonal to the extending direction of the wire body 32A.

The first end pad 32B of the second inductor wire 32 is connected to the first end of the wire body 32A. When viewed transparently in the direction orthogonal to the first principal surface 20A, the first end pad 32B of the second inductor wire 32 has a substantially rectangular shape with the long sides thereof extending along the first axis X. When viewed transparently in the direction orthogonal to the first principal surface 20A, the first end pad 32B of the second inductor wire 32 has a wire width larger than the wire width MW2 of the wire body 32A. When viewed in the direction orthogonal to the third axis Z, the wire width of the first end pad 32B is the dimension of the first end pad 32B in the direction orthogonal to the extending direction of the wire body 32A at the connection area between the first end pad 32B and the wire body 32A. Specifically, the wire width of the first end pad 32B of the second inductor wire 32 is the dimension in the direction extending along the second axis Y. The first end pad 32B of the second inductor wire 32 is connected to the corresponding columnar wire 40 with the corresponding via 50 interposed therebetween.

As illustrated in FIG. 2, the second end pad 32C of the second inductor wire 32 is connected to the second end of the wire body 32A. When viewed transparently in the direction orthogonal to the first principal surface 20A, the second end pad 32C of the second inductor wire 32 has a substantially rectangular shape with the long sides thereof extending along the first axis X. When viewed transparently in the direction orthogonal to the first principal surface 20A, the second end pad 32C of the second inductor wire 32 has a wire width larger than the wire width MW2 of the wire body 32A. The wire width of the second end pad 32C of the second inductor wire 32 is the dimension in the direction extending along the first axis X. The second end pad 32C of the second inductor wire 32 is connected to the corresponding columnar wire 40 with the corresponding via 50 interposed therebetween.

The number of turns in the second inductor wire 32 is 2.5. The number of turns in the second inductor wire 32 is the total number of turns from the outer peripheral edge of the first end pad 32B to the outer peripheral edge of the second end pad 32C via the outer peripheral edge of the wire body 32A.

As illustrated in FIG. 1, the third inductor wire 33 extends parallel to the first principal surface 20A within the element body 20. The configuration of the third inductor wire 33 is similar to the configuration of the first inductor wire 31. In detail, the third inductor wire 33 extends on the surface located toward the third positive direction Z1 of the first layer L1. Specifically, the third inductor wire 33 extends in the same plane as the first inductor wire 31. The third inductor wire 33 is located opposite the first inductor wire 31 with reference to the second inductor wire 32. The third inductor wire 33 has a wire body 33A, a first end pad 33B, and a second end pad 33C.

As illustrated in FIG. 2, when viewed transparently in the direction orthogonal to the first principal surface 20A, the wire body 33A of the third inductor wire 33 extends spirally. Of ends of the wire body 33A of the third inductor wire 33, an end located toward the second positive direction Y1 relative to the geometric center of the element body 20 will be defined as a first end. Furthermore, of the ends of the wire body 33A of the third inductor wire 33, an end located toward the second negative direction Y2 relative to the geometric center of the element body 20 will be defined as a second end.

When viewed transparently in the direction orthogonal to the first principal surface 20A, the wire body 33A of the third inductor wire 33 has a spiral shape that decreases in diameter from the first end toward the second end. The wire body 33A of the third inductor wire 33 extends spirally in the same direction as the wire body 31A of the first inductor wire 31.

A wire width MW3 of the wire body 33A of the third inductor wire 33 is fixed. The wire width MW3 is a dimension in a direction parallel to the first principal surface 20A and orthogonal to the extending direction of the wire body 33A of the third inductor wire 33. The wire width MW3 of the wire body 33A of the third inductor wire 33 is equal to the wire width MW1 of the wire body 31A of the first inductor wire 31.

A distance BW3 between wire segments of the wire body 33A of the third inductor wire 33 is larger than or equal to ⅓ of the wire width MW3 of the third inductor wire 33. Specifically, the minimum distance between wire segments of the third inductor wire 33 is larger than or equal to ⅓ of the minimum wire width of the third inductor wire 33. The distance BW3 between wire segments of the wire body 33A is substantially fixed over the entire range. The distance BW3 between wire segments of the wire body 33A of the third inductor wire 33 is the distance between wire segments of the wire body 33A in the direction orthogonal to the extending direction of the wire body 33A.

The first end pad 33B of the third inductor wire 33 is connected to the first end of the wire body 33A. When viewed transparently in the direction orthogonal to the first principal surface 20A, the first end pad 33B of the third inductor wire 33 has a substantially rectangular shape with the long sides thereof extending along the first axis X. When viewed transparently in the direction orthogonal to the first principal surface 20A, the first end pad 33B of the third inductor wire 33 has a wire width larger than the wire width MW3 of the wire body 33A. When viewed in the direction orthogonal to the third axis Z, the wire width of the first end pad 33B is the dimension of the first end pad 33B in the direction orthogonal to the extending direction of the wire body 33A at the connection area between the first end pad 33B and the wire body 33A. Specifically, the wire width of the first end pad 33B of the third inductor wire 33 is the dimension in the direction extending along the second axis Y. The first end pad 33B of the third inductor wire 33 is connected to the corresponding columnar wire 40 with the corresponding via 50 interposed therebetween.

As illustrated in FIG. 2, the second end pad 33C of the third inductor wire 33 is connected to the second end of the wire body 33A. When viewed transparently in the direction orthogonal to the first principal surface 20A, the second end pad 33C of the third inductor wire 33 has a substantially rectangular shape with the long sides thereof extending along the first axis X. When viewed transparently in the direction orthogonal to the first principal surface 20A, the second end pad 33C of the third inductor wire 33 has a wire width larger than the wire width MW3 of the wire body 33A. The wire width of the second end pad 33C of the third inductor wire 33 is the dimension in the direction extending along the first axis X. The second end pad 33C of the third inductor wire 33 is connected to the corresponding columnar wire 40 with the corresponding via 50 interposed therebetween.

The number of turns in the third inductor wire 33 is 1.5. In other words, the number of turns in the third inductor wire 33 is different from the number of turns in the first inductor wire 31 and the number of turns in the second inductor wire 32. The number of turns in the third inductor wire 33 is the total number of turns from the outer peripheral edge of the first end pad 33B to the outer peripheral edge of the second end pad 33C via the outer peripheral edge of the wire body 33A.

Of the three inductor wires 30 extending spirally, the first inductor wire 31 or the second inductor wire 32 will be defined as a specific inductor wire. In this case, 2.5, which is the number of turns in the specific inductor wire, is larger than 1.5, which is the number of turns in the third inductor wire 33.

As illustrated in FIG. 2, when viewed transparently in the direction orthogonal to the first principal surface 20A, a region surrounded by the outermost periphery of the first inductor wire 31 and a region surrounded by the outermost periphery of the second inductor wire 32 do not overlap each other. Furthermore, the region surrounded by the outermost periphery of the second inductor wire 32 and a region surrounded by the outermost periphery of the third inductor wire 33 do not overlap each other. Moreover, the region surrounded by the outermost periphery of the first inductor wire 31 and the region surrounded by the outermost periphery of the third inductor wire 33 do not overlap each other. The outermost periphery of each inductor wire 30 is the periphery located at the outermost side of the spiral of the spirally-extending inductor wire 30 when the inductor wire 30 is viewed in a direction orthogonal to the center axis of the spiral.

Vias and Columnar Wires

As illustrated in FIG. 3, the six vias 50 are disposed on the surface located toward the third positive direction Z1 of the second layer L2 in the element body 20. In detail, two of the six vias 50 are disposed on the first end pad 31B of the first inductor wire 31 and on the second end pad 31C of the first inductor wire 31. Other two of the six vias 50 are disposed on the first end pad 32B of the second inductor wire 32 and on the second end pad 32C of the second inductor wire 32. The remaining vias 50 are disposed on the first end pad 33B of the third inductor wire 33 and on the second end pad 33C of the third inductor wire 33. The material of the six vias 50 is the same as that of the inductor wires 30. In FIG. 3, only the vias 50 disposed on the first end pad 31B of the first inductor wire 31 and on the second end pad 31C of the first inductor wire 31 are illustrated.

As illustrated in FIG. 1, each columnar wire 40 has a substantially quadrangular prismatic shape. The material of the columnar wires 40 is the same as the material of the inductor wires 30. As illustrated in FIG. 3, each columnar wire 40 extends in the direction orthogonal to the first principal surface 20A. In detail, each columnar wire 40 extends from above the corresponding via 50 to the surface located toward the third positive direction Z1 of the third layer L3. In FIG. 3, only two of the columnar wires 40 connected to the first inductor wire 31 are illustrated.

The six columnar wires 40 are two first columnar wires 41, two second columnar wires 42, and two third columnar wires 43. The two first columnar wires 41 are further divided into a first-end columnar wire 41A and a second-end columnar wire 41B.

As illustrated in FIG. 3, the first-end columnar wire 41A is connected to the first end of the first inductor wire 31 with the corresponding via 50 interposed therebetween. In detail, the first-end columnar wire 41A is connected to the first end pad 31B of the first inductor wire 31 with the corresponding via 50 interposed therebetween. An end surface located toward the third positive direction Z1 of the first-end columnar wire 41A is exposed from the element body 20.

As illustrated in FIG. 2, when viewed in the direction orthogonal to the first principal surface 20A, the first-end columnar wire 41A has a substantially rectangular shape with the long sides thereof extending along the first axis X. The dimension of the first-end columnar wire 41A in the direction extending along the first axis X and the dimension thereof in the direction extending along the second axis Y are smaller than the respective dimensions of the first end pad 31B of the first inductor wire 31. Therefore, when viewed transparently in the third positive direction Z1, the first-end columnar wire 41A does not protrude from the first end pad 31B of the first inductor wire 31.

As illustrated in FIG. 3, the second-end columnar wire 41B is connected to the second end of the first inductor wire 31 with the corresponding via 50 interposed therebetween. In detail, the second-end columnar wire 41B is connected to the second end pad 31C of the first inductor wire 31 with the corresponding via 50 interposed therebetween. An end surface located toward the third positive direction Z1 of the second-end columnar wire 41B is exposed from the element body 20.

As illustrated in FIG. 2, when viewed in the direction orthogonal to the first principal surface 20A, the second-end columnar wire 41B has a substantially rectangular shape with the long sides thereof extending along the first axis X. The dimension of the second-end columnar wire 41B in the direction extending along the first axis X and the dimension thereof in the direction extending along the second axis Y are smaller than the respective dimensions of the second end pad 31C of the first inductor wire 31. Therefore, when viewed transparently in the third positive direction Z1, the second-end columnar wire 41B does not protrude from the second end pad 31C of the first inductor wire 31.

As illustrated in FIG. 2, the two second columnar wires 42 are further divided into a first-end columnar wire 42A and a second-end columnar wire 42B.

The first-end columnar wire 42A of the second columnar wires 42 is connected to the first end of the second inductor wire 32 with the corresponding via 50 interposed therebetween. In detail, the first-end columnar wire 42A is connected to the first end pad 32B of the second inductor wire 32 with the corresponding via 50 interposed therebetween. An end surface located toward the third positive direction Z1 of the first-end columnar wire 42A is exposed from the element body 20.

When viewed in the direction orthogonal to the first principal surface 20A, the first-end columnar wire 42A has a substantially rectangular shape with the long sides thereof extending along the first axis X. The dimension of the first-end columnar wire 42A in the direction extending along the first axis X and the dimension thereof in the direction extending along the second axis Y are smaller than the respective dimensions of the first end pad 32B of the second inductor wire 32. Therefore, when viewed transparently in the third positive direction Z1, the first-end columnar wire 42A does not protrude from the first end pad 32B of the second inductor wire 32.

The second-end columnar wire 42B is connected to the second end of the second inductor wire 32 with the corresponding via 50 interposed therebetween. In detail, the second-end columnar wire 42B is connected to the second end pad 32C of the second inductor wire 32 with the corresponding via 50 interposed therebetween. An end surface located toward the third positive direction Z1 of the second-end columnar wire 42B is exposed from the element body 20.

When viewed in the direction orthogonal to the first principal surface 20A, the second-end columnar wire 42B has a substantially rectangular shape with the long sides thereof extending along the second axis Y. The dimension of the second-end columnar wire 42B in the direction extending along the first axis X and the dimension thereof in the direction extending along the second axis Y are smaller than the respective dimensions of the second end pad 32C of the second inductor wire 32. Therefore, when viewed transparently in the third positive direction Z1, the second-end columnar wire 42B does not protrude from the second end pad 32C of the second inductor wire 32.

The two third columnar wires 43 are further divided into a first-end columnar wire 43A and a second-end columnar wire 43B.

As illustrated in FIG. 2, the first-end columnar wire 43A of the third columnar wires 43 is connected to the first end of the third inductor wire 33 with the corresponding via 50 interposed therebetween. In detail, the first-end columnar wire 43A is connected to the first end pad 33B of the third inductor wire 33 with the corresponding via 50 interposed therebetween. An end surface located toward the third positive direction Z1 of the first-end columnar wire 43A is exposed from the element body 20.

When viewed in the direction orthogonal to the first principal surface 20A, the first-end columnar wire 43A has a substantially rectangular shape with the long sides thereof extending along the first axis X. The dimension of the first-end columnar wire 43A in the direction extending along the first axis X and the dimension thereof in the direction extending along the second axis Y are smaller than the respective dimensions of the first end pad 33B of the third inductor wire 33. Therefore, when viewed transparently in the third positive direction Z1, the first-end columnar wire 43A does not protrude from the first end pad 33B of the third inductor wire 33.

The second-end columnar wire 43B is connected to the second end of the third inductor wire 33 with the corresponding via 50 interposed therebetween. In detail, the second-end columnar wire 43B is connected to the second end pad 33C of the third inductor wire 33 with the corresponding via 50 interposed therebetween. An end surface located toward the third positive direction Z1 of the second-end columnar wire 43B is exposed from the element body 20.

When viewed in the direction orthogonal to the first principal surface 20A, the second-end columnar wire 43B has a substantially rectangular shape with the long sides thereof extending along the first axis X. The dimension of the second-end columnar wire 43B in the direction extending along the first axis X and the dimension thereof in the direction extending along the second axis Y are smaller than the respective dimensions of the second end pad 33C of the third inductor wire 33. Therefore, when viewed transparently in the third positive direction Z1, the second-end columnar wire 43B does not protrude from the second end pad 33C of the third inductor wire 33.

Outer Electrodes

As illustrated in FIG. 3, the outer electrodes 60 are located at the first principal surface 20A of the element body 20. A first electrode layer 60A is connected to the corresponding columnar wire 40. Specifically, each outer electrode 60 is exposed from the first principal surface 20A. Moreover, the outer electrodes 60 are respectively connected to the corresponding columnar wires 40.

Each outer electrode 60 includes the first electrode layer 60A, a second electrode layer 60B, and a third electrode layer 60C. The first electrode layer 60A, the second electrode layer 60B, and the third electrode layer 60C are composed of different materials.

In each outer electrode 60, the first electrode layer 60A is located closest toward the element body 20. The first electrode layer 60A is connected to the corresponding columnar wire 40. The material of the first electrode layer 60A is Cu. The dimension of the first electrode layer 60A in the direction extending along the third axis Z is smaller than the dimension of each inductor wire 30 in the direction extending along the third axis Z.

The second electrode layer 60B is laminated on the surface located toward the third positive direction Z1 of the first electrode layer 60A. The material of the second electrode layer 60B is nickel. The dimension of the second electrode layer 60B in the direction extending along the third axis Z is substantially the same as the dimension of the first electrode layer 60A in the direction extending along the third axis Z.

The third electrode layer 60C is laminated on the surface located toward the third positive direction Z1 of the second electrode layer 60B. The material of the third electrode layer 60C is Au. The third electrode layer 60C is a surface layer of the outer electrode 60 located farthest from the first electrode layer 60A. The dimension of the third electrode layer 60C in the direction extending along the third axis Z is smaller than the dimension of the first electrode layer 60A in the direction extending along the third axis Z.

With regard to each outer electrode 60 including the first electrode layer 60A, the second electrode layer 60B, and the third electrode layer 60C, the dimension, in the direction extending along the third axis Z, of a portion provided on the first principal surface 20A is smaller than or equal to ½ of the dimension of each inductor wire 30 in the direction extending along the third axis Z. In detail, the dimension of each outer electrode 60 in the direction extending along the third axis Z is 0.01 mm. As mentioned above, the total value of the thickness of the first layer L1, the thickness of the second layer L2, and the thickness of the third layer L3, that is, the thickness of the element body 20, is about 0.13 mm. Therefore, the maximum dimension of the entire inductor component 10, including the element body 20 and each outer electrode 60, in the direction orthogonal to the third axis Z is smaller than or equal to 0.2 mm.

As illustrated in FIG. 1, the plurality of outer electrodes 60 include two first outer electrodes 61, two second outer electrodes 62, and two third outer electrodes 63.

The first outer electrodes 61 are further divided into a first end electrode 61A and a second end electrode 61B. The first end electrode 61A and the second end electrode 61B are disposed symmetrically in the direction extending along the second axis Y. Specifically, the position of the first end electrode 61A in the direction extending along the first axis X is aligned with the position of the second end electrode 61B in the direction extending along the first axis X.

As illustrated in FIG. 2, the first end electrode 61A of the first outer electrodes 61 is disposed at a corner located toward the first positive direction X1 and the second positive direction Y1 of the element body 20. The first end electrode 61A of the first outer electrodes 61 is connected to the first-end columnar wire 41A of the first columnar wires 41.

The second end electrode 61B of the first outer electrodes 61 is disposed at a corner located toward the first positive direction X1 and the second negative direction Y2 of the element body 20. The second end electrode 61B of the first outer electrodes 61 is connected to the second-end columnar wire 41B of the first columnar wires 41.

As illustrated in FIG. 1, the second outer electrodes 62 are further divided into a first end electrode 62A and a second end electrode 62B. The first end electrode 62A and the second end electrode 62B are disposed symmetrically in the direction extending along the second axis Y. Specifically, the position of the first end electrode 62A in the direction extending along the first axis X is aligned with the position of the second end electrode 61B in the direction extending along the first axis X.

As illustrated in FIG. 2, the first end electrode 62A of the second outer electrodes 62 is located toward the first negative direction X2 relative to the first end electrode 62A of the first outer electrodes 61. Specifically, the first end electrode 62A of the second outer electrodes 62 is arranged in the direction extending along the first axis X with a distance from the first end electrode 61A of the first outer electrodes 61. The first end electrode 62A of the second outer electrodes 62 is connected to the first-end columnar wire 42A of the second columnar wires 42.

The second end electrode 62B of the second outer electrodes 62 is located toward the first negative direction X2 relative to the second end electrode 61B of the first outer electrodes 61. Specifically, the second end electrode 62B of the second outer electrodes 62 is arranged in the direction extending along the first axis X with a distance from the second end electrode 61B of the first outer electrodes 61. The second end electrode 62B of the second outer electrodes 62 is connected to the second-end columnar wire 42B of the second columnar wires 42.

As illustrated in FIG. 1, the third outer electrodes 63 are further divided into a first end electrode 63A and a second end electrode 63B. The first end electrode 63A and the second end electrode 63B are disposed symmetrically in the direction extending along the second axis Y. Specifically, the position of the first end electrode 63A in the direction extending along the first axis X is aligned with the position of the second end electrode 63B in the direction extending along the first axis X.

As illustrated in FIG. 2, the first end electrode 63A of the third outer electrodes 63 is located toward the first negative direction X2 relative to the first end electrode 62A of the second outer electrodes 62. Specifically, the first end electrode 63A of the third outer electrodes 63 is arranged in the direction extending along the first axis X with a distance from the first end electrode 62A of the second outer electrodes 62. The first end electrode 63A of the third outer electrodes 63 is connected to the first-end columnar wire 43A of the third columnar wires 43.

The second end electrode 63B of the third outer electrodes 63 is located toward the first negative direction X2 relative to the second end electrode 62B of the second outer electrodes 62. Specifically, the second end electrode 63B of the third outer electrodes 63 is arranged in the direction extending along the first axis X with a distance from the second end electrode 62B of the second outer electrodes 62. The second end electrode 63B of the third outer electrodes 63 is connected to the second-end columnar wire 42B of the third columnar wires 43.

Insulation Layer

The inductor component 10 includes an insulation layer 70. The insulation layer 70 is located on the first principal surface 20A of the element body 20. The insulation layer 70 is located around the outer electrodes 60. Specifically, the insulation layer 70 covers the first principal surface 20A excluding the outer electrodes 60. In this embodiment, the insulation layer 70 is a solder resist layer. The dimension of the insulation layer 70 in the direction extending along the third axis Z is substantially the same as the dimension of each outer electrode 60 in the direction extending along the third axis Z.

Shape and Arrangement of Outer Electrodes

As illustrated in FIG. 2, when viewed in the direction orthogonal to the first principal surface 20A, the outer electrodes 60 all have a rectangular shape with the same aspect ratio. Moreover, the outer electrodes 60 all have the same size. Specifically, when viewed in the direction orthogonal to the first principal surface 20A, the outer electrodes 60 have the same area.

The outer electrodes 60 connected to, by using the corresponding columnar wires 40, to the ends of the inductor wire 30 located closest toward the first negative direction X2 among the plurality of inductor wires 30 will be defined as specific outer electrodes SP. Specifically, in this embodiment, the specific outer electrodes SP are the two third outer electrodes 63. A minimum distance SL1 from each first outer electrode 61 to an edge of the first principal surface 20A located toward the first positive direction X1 relative to the first outer electrode 61 is equal to a minimum distance SL2 from each specific outer electrode SP to an edge of the first principal surface 20A located toward the first negative direction X2 relative to the specific outer electrode SP. Specifically, the minimum distance SL1 between each first outer electrode 61 and the corresponding short side of the first principal surface 20A extending orthogonally to the first axis X is equal to the minimum distance SL2 between each specific outer electrode SP and the corresponding short side of the first principal surface 20A extending orthogonally to the first axis X.

As illustrated in FIG. 2, a minimum distance SD1 between the first end electrode 61A and the second end electrode 61B that connect to the first inductor wire 31 is equal to a minimum distance SD2 between the first end electrode 62A and the second end electrode 62B that connect to the second inductor wire 32. A minimum distance SD3 between the first end electrode 63A and the second end electrode 63B that connect to the third inductor wire 33 is equal to the minimum distance SD1 between the first end electrode 61A and the second end electrode 61B that connect to the first inductor wire 31 and the minimum distance SD2 between the first end electrode 62A and the second end electrode 62B that connect to the second inductor wire 32.

The outer electrodes 60 are arranged at an equal pitch in the direction extending along the first axis X. In detail, when viewed in the direction extending along the third axis Z, the geometric center of each outer electrode 60 is defined as a geometric center OE. In this case, the geometric center OE of the first end electrode 61A, the geometric center OE of the first end electrode 62A, and the geometric center OE of the first end electrode 63A are arranged parallel to the first axis X at an equal pitch. Likewise, the geometric center OE of the second end electrode 61B, the geometric center OE of the second end electrode 62B, and the geometric center OE of the second end electrode 63B are arranged parallel to the first axis X at an equal pitch.

Shape of Columnar Wires

As illustrated in FIG. 3, the maximum dimension of the third layer L3 in the direction extending along the third axis Z is equal to the maximum dimension of the sum of each columnar wire 40 and each via 50 in the direction extending along the third axis Z. Specifically, the maximum dimension of the sum of each columnar wire 40 and each via 50 in the direction extending along the third axis Z is 0.07 mm. The maximum dimension of each columnar wire 40 in the direction extending along the third axis Z is 0.06 mm. The maximum dimension of each via 50 in the direction extending along the third axis Z is 0.01 mm.

As mentioned above, the maximum dimension of the second layer L2 in the direction extending along the third axis Z is 0.04 mm. Specifically, the maximum dimension of each inductor wire 30 in the direction extending along the third axis Z is 0.04 mm. In other words, the maximum dimension of each columnar wire 40 in the direction extending along the third axis Z is larger than or equal to 1.5 times the maximum dimension of each inductor wire 30 in the direction extending along the third axis Z.

Arrangement of Inductor Wires

In this embodiment, when viewed in the direction orthogonal to the first principal surface 20A, each inductor wire 30 entirely has a rectangular spiral shape. Of the three inductor wires 30, the first inductor wire 31 has the largest wire length. The wire length decreases in the following order: the wire length of the second inductor wire 32 and the wire length of the third inductor wire 33. As illustrated in FIG. 2, of the three inductor wires 30, the first inductor wire 31 has the largest inner diameter. Specifically, the inner diameter of the second inductor wire 32 and the inner diameter of the third inductor wire 33 are smaller than the inner diameter of the first inductor wire 31. The inner diameter of the second inductor wire 32 is smaller than the inner diameter of the third inductor wire 33. The inner diameters of the inductor wires 30 are defined as follows.

When each spirally-extending inductor wire 30 is viewed in the direction orthogonal to the center axis of the spiral, the maximum dimension of the innermost periphery of the spiral of the inductor wire 30 is defined as an inner diameter. In this embodiment, a diagonal line extending from an inner edge located toward the first negative direction X2 and the second negative direction Y2 of each inductor wire 30 to an inner edge located toward the first positive direction X1 and the second positive direction Y1 of the inductor wire 30 is the inner diameter.

When viewed transparently in the direction orthogonal to the first principal surface 20A, the first inductor wire 31 has portions overlapping the second outer electrodes 62. In detail, when viewed transparently in the direction orthogonal to the first principal surface 20A, the first inductor wire 31 has a portion that overlaps the first end electrode 62A of the second outer electrodes 62 and a portion that overlaps the second end electrode 62B of the second outer electrodes 62. The first inductor wire 31 overlaps the first end electrode 62A and the second end electrode 62B at the outermost periphery of the spiral.

When viewed transparently in the direction orthogonal to the first principal surface 20A, the second inductor wire 32 has portions overlapping the third outer electrodes 63. In detail, when viewed transparently in the direction orthogonal to the first principal surface 20A, the second inductor wire 32 has a portion that overlaps the first end electrode 63A of the third outer electrodes 63 and a portion that overlaps the second end electrode 63B of the third outer electrodes 63. The second inductor wire 32 overlaps the first end electrode 63A and the second end electrode 63B at the outermost periphery of the spiral.

When viewed transparently in the direction orthogonal to the first principal surface 20A, the third inductor wire 33 does not have portions overlapping the outer electrodes 60 connected to other inductor wires 30. In other words, when viewed transparently in the direction orthogonal to the first principal surface 20A, the third inductor wire 33 does not overlap the first end electrodes 61A and 62A and the second end electrodes 61B and 62B.

Shape of Pads of Inductor Wires

As illustrated in FIG. 2, when viewed transparently in the direction orthogonal to the first principal surface 20A, the first end pad 31B of the first inductor wire 31 has a size and shape that are identical to the size and shape of the first end pad 32B of the second inductor wire 32. Furthermore, the size and shape of the first end pad 31B of the first inductor wire 31 are identical to the size and shape of the first end pad 33B of the third inductor wire 33. In other words, the three first end pads 31B, 32B, and 33B all have the same size and shape.

When viewed transparently in the direction orthogonal to the first principal surface 20A, the second end pad 31C of the first inductor wire 31 has a size and shape that are different from the size and shape of the second end pad 32C of the second inductor wire 32. In detail, the dimension of the second end pad 31C of the first inductor wire 31 in the direction extending along the first axis X is smaller than the dimension of the second end pad 32C of the second inductor wire 32 in the direction extending along the first axis X. Specifically, at least one selected from the size and the shape of the second end pad 31C of the first inductor wire 31 is different from at least one selected from the size and the shape of the second end pad 32C of the second inductor wire 32. In this embodiment, the size of the second end pad 31C of the first inductor wire 31 is different from the size of the second end pad 32C of the second inductor wire 32. Moreover, the shape of the second end pad 31C of the first inductor wire 31 is different from the shape of the second end pad 32C of the second inductor wire 32. Specifically, the size and shape of the second end pad 31C of the first inductor wire 31 are both different from the size and shape of the second end pad 32C of the second inductor wire 32. On the other hand, the size and shape of the second end pad 31C of the first inductor wire 31 are the same as the size and shape of the second end pad 33C of the third inductor wire 33. Accordingly, of the three second end pads 31C, 32C, and 33C, only the second end pad 32C is larger than the other second end pads 31C and 33C.

When at least one of the inductor wires 30 is viewed transparently in the direction orthogonal to the first principal surface 20A, the two pads of the inductor wire 30 have the same size and the same shape. In detail, as illustrated in FIG. 2, the size and shape of the first end pad 31B of the first inductor wire 31 among the inductor wires 30 are the same as the size and shape of the second end pad 31C. The size and shape of the first end pad 33B of the third inductor wire 33 are also the same as the size and shape of the second end pad 33C. On the other hand, the size and shape of the first end pad 32B of the second inductor wire 32 are different from the size and shape of the second end pad 32C. In other words, of the six pads, only the second end pad 32C of the second inductor wire 32 has a size and shape different from those of the other pads.

Arrangement of Pads of Inductor Wires

As illustrated in FIG. 2, when viewed in the direction orthogonal to the first principal surface 20A, the geometric centers of the first end pads of the inductor wires 30 are located on the same line that is parallel to the direction extending along the first axis X. Specifically, a geometric center CR1 of the first end pad 31B of the first inductor wire 31, a geometric center CR2 of the first end pad 32B of the second inductor wire 32, and a geometric center CR3 of the first end pad 33B of the third inductor wire 33 are located on the same line that is parallel to the first axis X.

When viewed in the direction orthogonal to the first principal surface 20A, the geometric centers of the second end pads of the inductor wires 30 are not located on the same line that is parallel to the direction extending along the first axis X. In detail, a geometric center CL1 of the second end pad 31C of the first inductor wire 31 and a geometric center CL2 of the second end pad 32C of the second inductor wire 32 are located on the same line that is parallel to the first axis X. On the other hand, a geometric center CL3 of the second end pad 33C of the third inductor wire 33 is not located on a line extending through the geometric center CL1 and the geometric center CL2. In this embodiment, the geometric center CL3 of the second end pad 33C of the third inductor wire 33 is located toward the second negative direction Y2 relative to the geometric center CL1 and the geometric center CL2.

Arrangement of Columnar Wires

Each columnar wire 40 is disposed at an eccentric location relative to the corresponding outer electrode 60. In detail, when viewed in the direction extending along the third axis Z, a geometric center of a surface of each columnar wire 40 exposed from the first principal surface 20A will be defined as a geometric center OP. In this case, the geometric center OP of the columnar wire 40 is out of alignment with the geometric center OE of the outer electrode 60 connected to the columnar wire 40. In other words, the geometric center OP of the columnar wire 40 is not aligned with the geometric center OE of the outer electrode 60.

A vector extending from the geometric center OP of the first-end columnar wire 41A of the first columnar wires 41 toward the geometric center OE of the first end electrode 61A of the first outer electrodes 61 will be defined as a first vector BC1. A vector extending from the geometric center OP of the first-end columnar wire 42A of the second columnar wires 42 toward the geometric center OE of the first end electrode 62A of the second outer electrodes 62 will be defined as a second vector BC2. In this case, the first vector BC1 is different from the second vector BC2. In detail, the orientation of the first vector BC1 is different from the orientation of the second vector BC2, and the magnitude of the first vector BC1 is different from the magnitude of the second vector BC2.

A vector extending from the geometric center OP of the first-end columnar wire 43A of the third columnar wires 43 toward the geometric center OE of the first end electrode 63A of the third outer electrodes 63 will be defined as a fifth vector BC5. The first vector BC1 is different from the fifth vector BC5. Moreover, the second vector BC2 is different from the fifth vector BC5.

A vector extending from the geometric center OP of the second-end columnar wire 41B of the first columnar wires 41 toward the geometric center OE of the second end electrode 61B of the first outer electrodes 61 will be defined as a third vector BC3. In this case, the first vector BC1 is different from the third vector BC3. In detail, the orientation of the first vector BC1 is different from the orientation of the third vector BC3, and the magnitude of the first vector BC1 is different from the magnitude of the third vector BC3.

The second columnar wires 42 and the third columnar wires 43 also have the same relationship that the third vector BC3 has with respect to the orientation of the first vector BC1 in the first columnar wires 41. A vector extending from the geometric center OP of the second-end columnar wire 42B of the second columnar wires 42 toward the geometric center OE of the second end electrode 62B of the second outer electrodes 62 will be defined as a fourth vector BC4. The second vector BC2 is different from the fourth vector BC4. Likewise, a vector extending from the geometric center OP of the second-end columnar wire 43B of the third columnar wires 43 toward the geometric center OE of the second end electrode 63B of the third outer electrodes 63 will be defined as a sixth vector BC6. In this case, the fifth vector BC5 is different from the sixth vector BC6.

With regard to the first columnar wires 41, it is assumed that an imaginary line segment L connecting the geometric center OP of the first-end columnar wire 41A and the geometric center OP of the second-end columnar wire 41B is drawn. In this case, the line segment L is not parallel to either of the first axis X and the second axis Y. Specifically, the line segment L is not parallel to any of the sides of the first principal surface 20A. Although not illustrated, with regard to the second columnar wires 42, it is assumed that an imaginary line segment connecting the geometric center OP of the first-end columnar wire 42A and the geometric center OP of the second-end columnar wire 42B is drawn. Likewise, with regard to the third columnar wires 43, it is assumed that an imaginary line segment connecting the geometric center OP of the first-end columnar wire 43A and the geometric center OP of the second-end columnar wire 43B is drawn. These two imaginary line segments are also not parallel to the first axis X and the second axis Y.

In the direction extending along the first axis X, the region where the first-end columnar wire 41A exists partially or entirely overlaps the region where the second-end columnar wire 41B exists. Specifically, when the element body 20 is viewed transparently in the direction extending along the second axis Y, the first-end columnar wire 41A and the second-end columnar wire 41B of the first columnar wires 41 overlap each other. The same applies to the second columnar wires 42 and the third columnar wires 43. In other words, the first-end columnar wire 42A and the second-end columnar wire 42B of the second columnar wires 42 overlap each other. Moreover, the first-end columnar wire 43A and the second-end columnar wire 43B of the third columnar wires 43 overlap each other.

Simulation with Changed Dimension of Third Layer of Element Body

A simulation is performed with respect to a Q-value of the inductor component 10 obtained when the third layer L3 of the element body 20 is changed in length.

In the simulation, the dimension of the third layer L3 in the direction extending along the third axis Z is changed for every 10 μm, and a Q-value acquired by the inductor component 10 at each dimension is calculated. The dimension of the third layer L3 in the direction extending along the third axis Z is changed within a range between 10 μm and 90 μm. The simulation is performed such that the dimension of each columnar wire 40 in the direction extending along the third axis Z is increased every time the dimension of the third layer L3 in the direction extending along the third axis Z is increased.

A Q-value is calculated with respect to each of the first inductor wire 31, the second inductor wire 32, and the third inductor wire 33. A Q-value decreases with increasing eddy current loss occurring when electric current is applied to the inductor component 10.

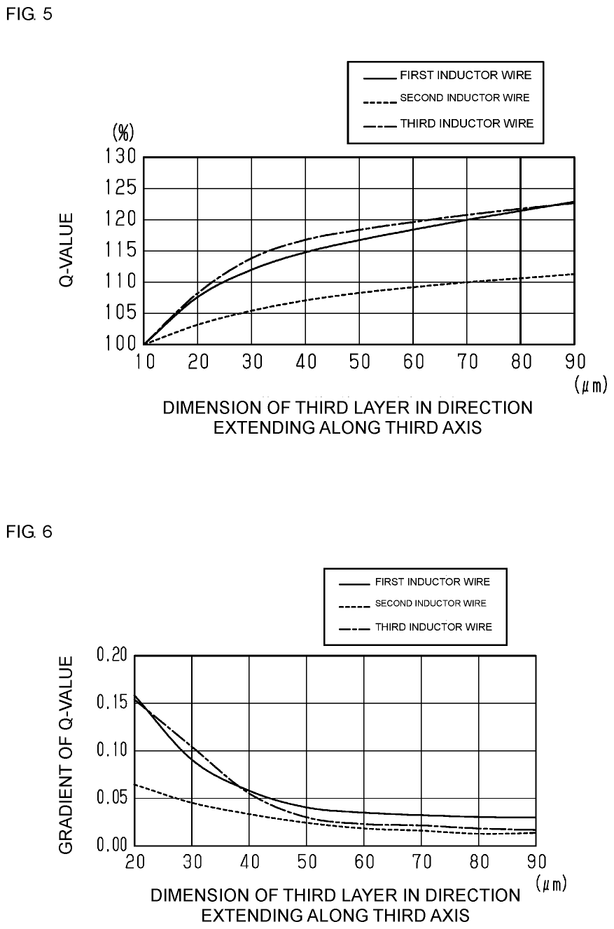

As illustrated in FIG. 5, the Q-value of each inductor wire 30 increases with increasing dimension of the third layer L3 in the direction extending along the third axis Z. In FIG. 5, the Q-value is 100% when the dimension of the third layer L3 in the direction extending along the third axis Z is 10 μm.

As illustrated in FIG. 6, with regard to a change in the Q-value obtained with respect to each inductor wire 30 as a result of the above simulation, a gradient of the change is calculated. In a range where the dimension of the third layer L3 in the direction extending along the third axis Z is larger than or equal to 20 μm and smaller than 40 μm (i.e., from 20 μm to smaller than 40 μm), a difference between the gradient of the Q-value of the second inductor wire 32 and the gradients of the Q-values of the other inductor wires 30 is large. On the other hand, when the dimension of the third layer L3 in the direction extending along the third axis Z is larger than or equal to 40 μm, the gradients of the Q-values of the inductor wires 30 converge, so that the difference decreases for each inductor wire 30. When the dimension of the third layer L3 in the direction extending along the third axis Z is larger than or equal to 50 μm, the gradients of the Q-values of the inductor wires 30 further converge and indicate substantially similar values within a range from 0.02 to 0.04. Specifically, when the dimension of the third layer L3 in the direction extending along the third axis Z is larger than or equal to 40 μm, the difference between the gradients of the Q-values of the inductor wires 30 decreases regardless of the magnitude of the dimension. Furthermore, when the dimension of the third layer L3 in the direction extending along the third axis Z is larger than or equal to 50 μm, the gradients of the Q-values of the inductor wires 30 further decrease regardless of the magnitude of the dimension, and indicate substantially similar values.

In contrast to this embodiment, a simulation is similarly performed by using an inductor component, as a model, in which the first inductor wire does not have a portion overlapping the second outer electrodes when viewed transparently in the direction orthogonal to the first principal surface.

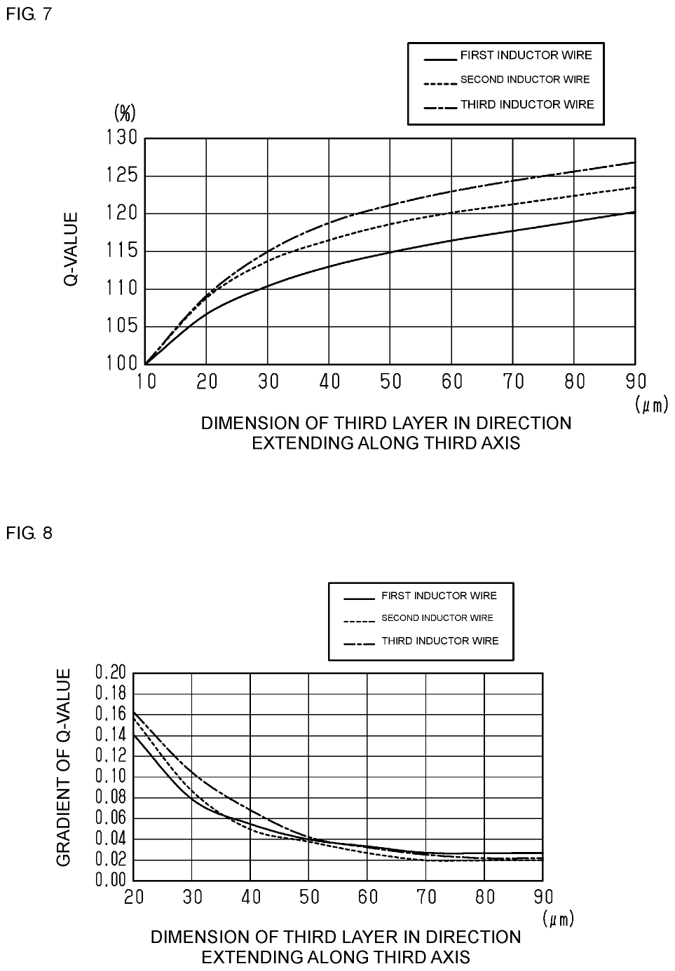

As illustrated in FIG. 7, a Q-value with respect to each inductor wire is calculated using the aforementioned inductor component as the model. In this simulation, each Q-value is similarly calculated by setting the acquired Q-value to 100% when the dimension of the third layer in the direction extending along the third axis Z is 10 μm. The Q-value with respect to each inductor wire increases with increasing dimension of the third layer in the direction extending along the third axis Z. Specifically, in the simulation targeted to the aforementioned model, results similar to those in the simulation targeted to the inductor component 10 according to this embodiment are obtained. Furthermore, as illustrated in FIG. 8, with regard to a change in the Q-value with respect to each inductor wire, a gradient of the change is calculated. In the simulation targeted to the aforementioned model, when the dimension of the third layer in the direction extending along the third axis Z is larger than or equal to 40 μm, the difference between the gradients of the Q-values of the inductor wires decreases regardless of the magnitude of the dimension. When the dimension of the third layer in the direction extending along the third axis Z is larger than or equal to 50 μm, the difference between the gradients of the Q-values of the inductor wires further decreases regardless of the magnitude of the dimension, thus indicating substantially similar values.

### Advantages of Embodiment

(1) Assuming that electric current is applied to the inductor component 10, magnetic flux flows in the direction orthogonal to the first principal surface 20A. Then, the generated magnetic flux penetrates the outer electrodes 60. Accordingly, an eddy current loss occurring in the inductor component 10 increases with increasing magnetic flux penetrating the outer electrodes 60. In other words, the Q-value of the inductor component 10 decreases.

In the above embodiment, the minimum distance of the third layer L3, that is, the minimum distance from the outer electrodes 60 to the inductor wires 30, is larger than or equal to 0.04 mm. According to this dimensional relationship, the magnetic flux generated when electric current is applied to each inductor wire 30 can be prevented from penetrating each outer electrode 60. Therefore, according to this configuration, an eddy current loss occurring when electric current is applied to each inductor wire 30 can be suppressed.

As mentioned above, if the minimum distance is larger than or equal to 0.04 mm, the gradient of the Q-value of the inductor component 10 when electric current is applied to the inductor component 10 becomes similar values among the inductor wires 30. Specifically, when the minimum distance from the outer electrodes 60 to the inductor wires 30 is larger than or equal to 0.04 mm, even if dimensional variations occur to some extent among multiple fabricated inductor components 10, stable characteristics can be obtained with respect to the Q-values of the inductor components 10.

(2) In the above embodiment, the minimum distance from the first principal surface 20A to each inductor wire 30 is larger than or equal to twice the minimum distance from the second principal surface 20B to each inductor wire 30. With this configuration, the distance from the second principal surface 20B to each inductor wire 30 can be reduced while the distance from the first principal surface 20A to each inductor wire 30 is sufficiently maintained. Specifically, an increase in the dimension of the element body 20 in the direction orthogonal to the first principal surface 20A can be suppressed.

(3) In the above embodiment, each inductor wire 30 extends spirally. Moreover, the inductor wires 30 extend spirally in the same direction. With this configuration, the direction of the electric current can be made uniform among the inductor wires 30, and the coupling coefficient can be readily adjusted among the inductor wires 30.

(4) In the above embodiment, the maximum dimension of each outer electrode 60 in the direction orthogonal to the first principal surface 20A is smaller than or equal to ½ of the maximum dimension of each inductor wire 30 in the direction orthogonal to the first principal surface 20A. When the dimension of each outer electrode 60 in the direction orthogonal to the first principal surface 20A is small, the dimension of the inductor component 10 in the direction extending along the third axis Z can be reduced.

(5) In the above embodiment, the distance BW1 between wire segments of the wire body 31A of the first inductor wire 31 is larger than or equal to ⅓ of the minimum wire width of each inductor wire 30. Specifically, the minimum distance between wire segments of the first inductor wire 31 is larger than or equal to ⅓ of the minimum wire width of each inductor wire 30. With this configuration, the distance between wire segments can be ensured. Accordingly, stray capacitance occurring between wire segments can be reduced.

(6) In the above embodiment, the maximum dimension of each columnar wire 40 in the direction orthogonal to the first principal surface 20A is larger than or equal to 1.5 times the maximum dimension of each inductor wire 30 in the direction orthogonal to the first principal surface 20A. Accordingly, the thickness of each columnar wire 40 is increased relative to the thickness of each inductor wire 30, so that magnetic flux penetrating through each outer electrode 60 can be suppressed.

(7) In the above embodiment, with regard to the first inductor wire 31, the line segment L connecting the geometric center OP of the first-end columnar wire 41A and the geometric center OP of the second-end columnar wire 41B is not parallel to either of the first axis X and the second axis Y. Specifically, the positional relationship between the first-end columnar wire 41A and the second-end columnar wire 41B of the first columnar wires 41 is not limited to a specific positional relationship. Therefore, the positional relationship of the columnar wires 40 can be set in accordance with, for example, the shape of the inductor wires for obtaining a desired inductance value.

(8) In the above embodiment, when viewed in the direction orthogonal to the first principal surface 20A, the plurality of outer electrodes 60 have the same shape and area. With this configuration, the amount of solder to be applied to the outer electrodes 60 can be made uniform when the inductor component 10 is to be mounted onto a substrate. Accordingly, the solidification rate of the solder applied to the outer electrodes 60 can be made substantially uniform. Specifically, this configuration facilitates management of the solder solidification time. As a result, a situation where the inductor component 10 is positionally misaligned with the substrate due to misalignment of the inductor component 10 prior to the solidification of the solder can be suppressed. Moreover, this configuration eliminates the need to perform a troublesome task of adjusting the amount of solder to be applied to each outer electrode 60 when the solder is to be applied to the outer electrode 60.

(9) In the above embodiment, the maximum dimension of the element body 20 in the direction orthogonal to the first principal surface 20A is 0.13 mm. Accordingly, the element body 20 having such a small thickness enables mounting to the land side of a package substrate. From this viewpoint, the maximum dimension of the element body 20 in the direction orthogonal to the first principal surface 20A is preferably smaller than or equal to 0.15 mm.

(10) In the above embodiment, when viewed transparently in the direction orthogonal to the first principal surface 20A, the first inductor wire 31 extends to locations above the second outer electrodes 62 connected to the second inductor wire 32. It is assumed that, when the element body 20 is viewed transparently in the direction orthogonal to the first principal surface 20A, the element body 20 is trisected in the direction extending along the first axis X. In this case, the first inductor wire 31 mainly extends to a central region where the second inductor wire 32 is disposed. Therefore, the first inductor wire 31 can be increased in length. As a result, the difference in wire length between the first inductor wire 31 and the other inductor wires 30 can be increased. By varying the wire length in this manner, a preferred inductance value can be acquired for each inductor wire 30.

(11) In the above embodiment, the geometric centers of the first end pads of the inductor wires 30 are located on the same line that is parallel to the first axis X. On the other hand, the second end pad 33C of the third inductor wire 33 and the second end pad 31C of the first inductor wire 31 are not located on the same line that is parallel to the first axis X. With this configuration, the distance between the first end pad 33B and the second end pad 33C of the third inductor wire 33 in the direction extending along the second axis Y is different from the distance between the first end pad and the second end pad of each of the other inductor wires 30 in the direction extending along the second axis Y. With this positional difference of the pads, the wire lengths of the wire bodies of the respective inductor wires 30 can be readily designed to different wire lengths. Accordingly, a different inductance value can be obtained for each inductor wire 30.

(12) In the above embodiment, the size and shape of the second end pad 31C of the first inductor wire 31 are different from the size and shape of the second end pad 32C of the second inductor wire 32. Accordingly, the pads of the inductor wires 30 are intentionally varied in shape instead of being made uniform in shape, so that the degree of design freedom with respect to the wire length and shape of the inductor wires 30 can be increased. Consequently, the difference between the inductance value of the first inductor wire 31 and the inductance value of the second inductor wire 32 can be readily increased.

(13) In the above embodiment, the geometric center OP of the first-end columnar wire 41A of the first inductor wire 31 is out of alignment with the geometric center OE of the first end electrode 61A. Furthermore, the geometric center OP of the second-end columnar wire 41B of the first inductor wire 31 is out of alignment with the geometric center OE of the second end electrode 61B. The first vector BC1 extending from the geometric center OP of the first-end columnar wire 41A toward the geometric center OE of the first end electrode 61A and the third vector BC3 extending from the geometric center OP of the second-end columnar wire 41B toward the geometric center OE of the second end electrode 61B are different from each other. In other words, the positions of the columnar wires 40 relative to the outer electrodes 60 are not limited to specific positions. Accordingly, the degree of freedom with respect to the designing of, for example, the connection positions between the columnar wires 40 and the outer electrodes 60 can be increased. Accordingly, the degree of design freedom for each inductor wire 30 is also enhanced, and the inductor wires 30 can readily have different inductance values.

(14) In the above embodiment, the geometric center OP of the first-end columnar wire 41A of the first inductor wire 31 is out of alignment with the geometric center OE of the first end electrode 61A. Furthermore, the geometric center OP of the first-end columnar wire 42A of the second inductor wire 32 is out of alignment with the geometric center OE of the first end electrode 62A. The first vector BC1 and the second vector BC2 are different from each other. With this configuration, the degree of freedom with respect to the designing of, for example, the connection positions between the columnar wires 40 and the outer electrodes 60 can be increased. Accordingly, the degree of design freedom for each inductor wire 30 is also enhanced, and the inductor wires 30 can readily have different inductance values.

(15) In the above embodiment, the number of turns in each inductor wire 30 is larger than or equal to 1.5. With this configuration, the maximum inductance value obtained from each inductor wire 30 is improved.

### Modifications

This embodiment may be modified as follows. This embodiment and the following modifications can be implemented by being combined with each other within a range in which no technical contradictions occur.

In the above embodiment, at least one selected from the plurality of inductor wires 30 does not have to be spiral. Specifically, the number of turns in the at least one selected from the plurality of inductor wires 30 may be smaller than or equal to 1. For example, as in an example illustrated in FIG. 4, the third inductor wire 33 may have a meandering shape. Alternatively, the inductor wires 30 may have a straight shape extending parallel to the second axis Y or may be bent into an arched shape. Even if the at least one selected from the plurality of inductor wires 30 has the aforementioned shape of the inductor wire 30, the advantages described in (1) above are still achieved. Furthermore, the number of turns in all of the inductor wires 30 may be smaller than or equal to 1.

In the above embodiment, the maximum dimension, including the element body 20 and each outer electrode 60, in the direction orthogonal to the first principal surface 20A may be larger than 0.2 mm.

In the above embodiment, the dimensions of the first layer L1, the second layer L2, and the third layer L3 of the element body 20 in the direction extending along the third axis Z are not limited to those in the above embodiment. The maximum dimension, including the first layer L1, the second layer L2, and the third layer L3, in the direction extending along the third axis Z may be larger than 0.13 mm.

In the above embodiment, the maximum dimension of the third layer L3 in the direction extending along the third axis Z does not have to be larger than or equal to twice the maximum dimension of the first layer L1 in the direction extending along the third axis Z.

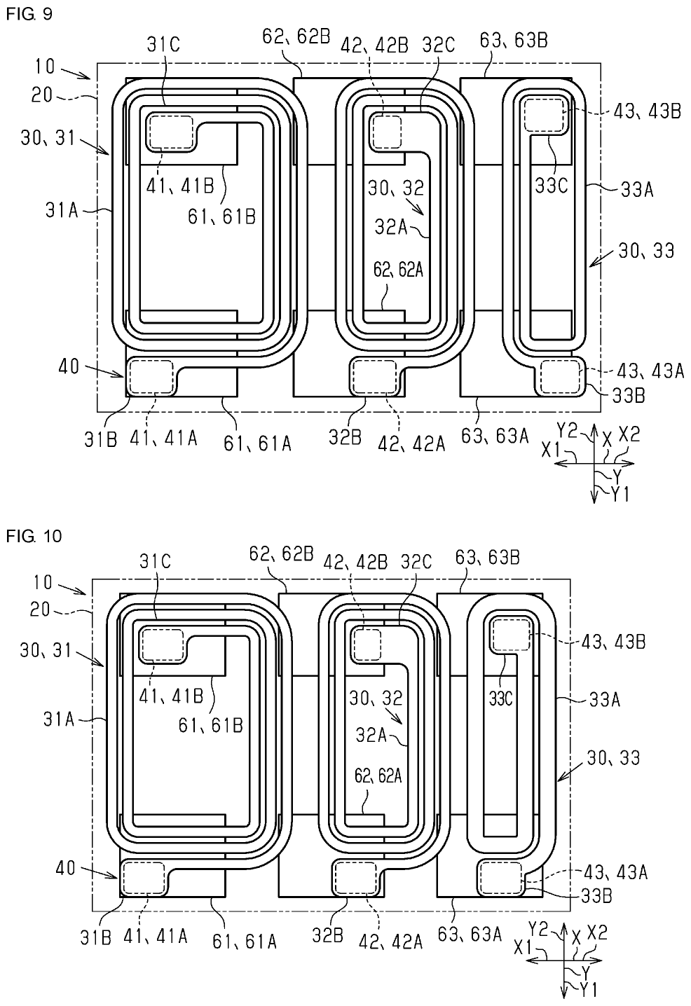

In the above embodiment, at least one inductor wire 30 selected from the plurality of inductor wires 30 may extend spirally in a direction different from that of another inductor wire 30. For example, in an example illustrated in FIG. 9, when the third inductor wire 33 is viewed transparently in the direction orthogonal to the first principal surface 20A, the wire body 33A of the third inductor wire 33 has a spiral shape that decreases in diameter from the first end toward the second end. The wire body 33A of the third inductor wire 33 in the example illustrated in FIG. 9 extends spirally in a direction different from that of the wire body 31A of the first inductor wire 31. Accordingly, the inductor wires 30 used extend spirally in different directions, thereby achieving a coupling coefficient between the inductor wires 30, which is difficult to achieve when the inductor wires 30 used extend spirally in the same direction.

In the above embodiment, the wire width of one inductor wire 30 of the plurality of inductor wires 30 may be different from the wire width of another inductor wire 30. For example, as in an example illustrated in FIG. 10, the wire width MW3 of the third inductor wire 33 may be larger than the wire width MW1 of the first inductor wire 31. As in the example illustrated in FIG. 10, the use of preferred wire widths for the inductor wires 30 enables acquisition of favorable inductance values for the respective inductor wires 30. As an alternative to the example illustrated in FIG. 10, the wire width MW1 of the wire body 31A of the first inductor wire 31, the wire width MW2 of the second inductor wire 32, and the wire width MW3 of the third inductor wire 33 may be different from one another.

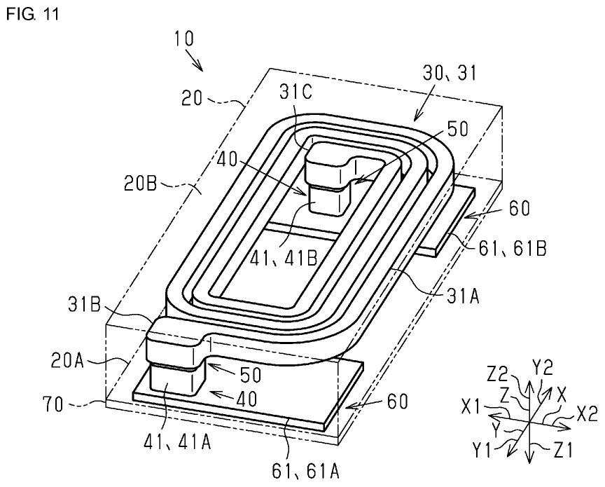

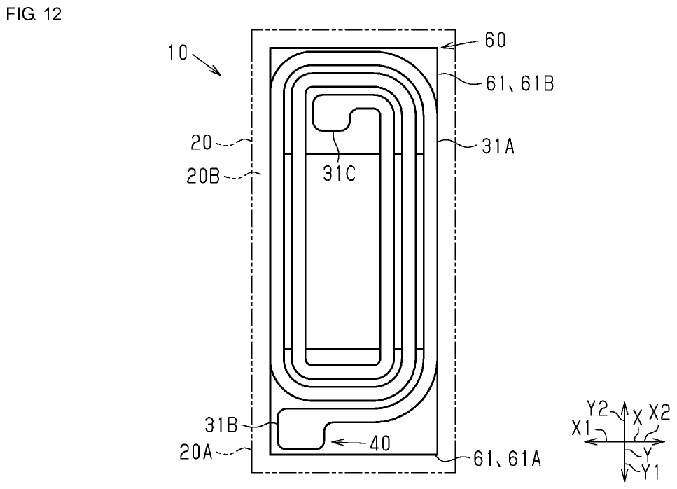

In the above embodiment, the inductor component 10 may have at least one inductor wire 30. In an example illustrated in FIG. 11, the inductor component 10 includes the element body 20, the first inductor wire 31, two columnar wires 40, and two outer electrodes 60. Furthermore, in the example illustrated in FIG. 11, the inductor component 10 includes two vias 50 and the insulation layer 70. Specifically, the inductor component 10 in the example illustrated in FIG. 11 is obtained by omitting components related to the second inductor wire 32 and the third inductor wire 33, the columnar wires 40 connected to these wires, the vias 50, and the outer electrodes 60 from the inductor component 10 according to the above embodiment. Therefore, in the inductor component 10 in the example illustrated in FIG. 11, the minimum distance from the first principal surface 20A to each inductor wire 30 is larger than or equal to 0.04 mm. In the inductor component 10 in the example illustrated in FIG. 11, the advantages described in (1) above are achieved. As in an example illustrated in FIG. 12, when viewed transparently in the direction orthogonal to the first principal surface 20A, each inductor wire 30 may be accommodated within the corresponding outer electrode 60 in the direction extending along the first axis X.

In the above embodiment, the outer electrodes 60 are omittable from the inductor component 10. If the outer electrodes 60 are to be omitted, the surface of each columnar wire 40 exposed from the first principal surface 20A may be directly connected to a terminal on a substrate.

In the above embodiment, the material of the element body 20 is not limited to the example in the above embodiment. For example, the element body 20 may contain a magnetic material. For example, the material of the element body 20 may be magnetic powder composed of metal other than Fe. Examples include Ni, Cr, Cu, Al, and an alloy of these materials.

In the above embodiment, when viewed transparently in the direction orthogonal to the first principal surface 20A, the first inductor wire 31 does not have to have portions overlapping the second outer electrodes 62.

In the above embodiment, the inductor wires 30 may include only the first inductor wire 31 and the second inductor wire 32. Alternatively, the inductor component 10 may include four or more inductor wires 30.

In the above embodiment, when viewed transparently in the direction orthogonal to the first principal surface 20A, the first inductor wire 31 does not have to have a portion overlapping each of the two second outer electrodes 62. Specifically, when viewed transparently in the direction orthogonal to the first principal surface 20A, the first inductor wire 31 may overlap at least one of the first end electrode 62A of the second outer electrodes 62 and the second end electrode 62B of the second outer electrodes 62. Moreover, the first inductor wire 31 does not have to overlap either of the two second outer electrodes 62.

In the above embodiment, the second inductor wire 32 does not have to have portions overlapping the third outer electrodes 63.

In the above embodiment, the inductor wires 30 may all have the same inner diameter.

In the above embodiment, the inductor wires 30 may all have the same number of turns.

The inductor wires 30 may be formed by a known method, such as the electrolytic plating method, the electroless plating method, the sputtering method, the etching method, or the printing-sintering method. The same applies to the columnar wires 40 and the vias 50.

In the above embodiment, the wire body 31A of the first inductor wire 31 may have a spiral shape that increases in diameter from the first end toward the second end of the wire body 31A. The same applies to the second inductor wire 32 and the third inductor wire 33.

In the above embodiment, the minimum distance between wire segments of each inductor wire 30 may be smaller than ⅓ of the minimum wire width of the inductor wire 30.

In the above embodiment, the number of turns in each inductor wire 30 is not limited to the example in the above embodiment. For example, the number of turns in each inductor wire 30 may be smaller than 1.5.

In the above embodiment, each inductor wire 30 does not have to have pads. Specifically, each inductor wire 30 may be constituted of the wire body alone.

In the above embodiment, when viewed transparently in the direction orthogonal to the first principal surface 20A, the shape of each pad is not limited to the example in the above embodiment. For example, each pad may be circular-shaped or square-shaped. If each pad is, for example, circular, when viewed in the direction orthogonal to the third axis Z, the wire width of the pad is the maximum dimension of the pad in the direction orthogonal to the extending direction of the wire body at the connection area between the pad and the wire body connected to the pad.

In the above embodiment, the arrangement of the outer electrodes 60 is not limited to the example in the above embodiment. For example, the minimum distance SL1 between each first outer electrode 61 and the corresponding short side of the first principal surface 20A may be different from the minimum distance SL2 between each third outer electrode 63 and the corresponding short side of the first principal surface 20A. Furthermore, the minimum distance SD1 between the first end electrode 61A and the second end electrode 61B of the first outer electrodes 61 and the minimum distance SD2 between the first end electrode 62A and the second end electrode 62B of the second outer electrodes 62 may be different from each other.

In the above embodiment, when viewed in the direction orthogonal to the first principal surface 20A, the shape of each outer electrode 60 is not limited to the rectangular shape. For example, each outer electrode 60 may be circular or polygonal. Moreover, the outer electrodes 60 may have different shapes.

In the above embodiment, when viewed in the direction orthogonal to the first principal surface 20A, the outer electrodes 60 may have different areas.

In the above embodiment, the dimension of each outer electrode 60 in the direction extending along the third axis Z is not limited to the example in the above embodiment. The dimension of each outer electrode 60 in the direction extending along the third axis Z may be larger than or equal to the dimension of each inductor wire 30 in the direction extending along the third axis Z. Furthermore, the dimension of the first electrode layer 60A of each outer electrode 60 in the direction extending along the third axis Z may be larger than the dimension of each inductor wire 30 in the direction extending along the third axis Z. Moreover, the maximum dimension of each outer electrode 60 in the direction extending along the third axis Z may be larger than ½ of the maximum dimension of each inductor wire 30 in the direction extending along the third axis Z.

In the above embodiment, each outer electrode 60 does not have to be constituted of multiple laminated layers. For example, in the above embodiment, each outer electrode 60 may be constituted of a single metallic layer.

In the above embodiment, each outer electrode 60 may further have a layer composed of a different material. If each outer electrode 60 is constituted of multiple layers, any of the multiple layers may be composed of the same material. Moreover, each outer electrode 60 may be constituted of two metallic layers.

In the above embodiment, the materials of the first electrode layer 60A, the second electrode layer 60B, and the third electrode layer 60C are not limited to the examples in the above embodiment. For example, the material of the third electrode layer 60C may be Sn or an alloy containing Au and Sn.

In the above embodiment, each columnar wire 40 does not have to extend parallel to the third axis Z. Each columnar wire 40 may intersect the first principal surface 20A so long as the columnar wire 40 connects the corresponding inductor wire 30 to the corresponding outer electrode 60.

In the above embodiment, the maximum dimension of each columnar wire 40 in the direction extending along the third axis Z may be smaller than the maximum dimension of each inductor wire 30 in the direction extending along the third axis Z. Specifically, the maximum dimension of each columnar wire 40 in the direction extending along the third axis Z may be smaller than 1.5 times the maximum dimension of each inductor wire 30 in the direction extending along the third axis Z.

When the dimension of each columnar wire 40 in the direction extending along the third axis Z is larger than the maximum dimension of the columnar wire 40 in the direction parallel to the first principal surface 20A, magnetic flux occurring when electric current is applied to the inductor component 10 is less likely to penetrate each outer electrode 60. Therefore, the dimension of each columnar wire 40 in the direction extending along the third axis Z is preferably larger than or equal to 1.5 times the maximum dimension of the columnar wire 40 in the direction parallel to the first principal surface 20A.

In the above embodiment, the first vector BC1 and the third vector BC3 may be identical to each other. Furthermore, the magnitude of the first vector BC1 and the magnitude of the third vector BC3 may be equal to each other, and the orientation of the first vector BC1 and the orientation of the third vector BC3 may be different from each other. Moreover, the magnitude of the first vector BC1 and the magnitude of the third vector BC3 may be different from each other, and the orientation of the first vector BC1 and the orientation of the third vector BC3 may be the same. Furthermore, the geometric center OP of each first columnar wire 41 and the geometric center OE of the outer electrode 60 connected to the first columnar wire 41 may be aligned with each other. The same applies to the second columnar wires 42 and the third columnar wires 43.

In the above embodiment, with regard to the first columnar wires 41, the first vector BC1 and the second vector BC2 may be identical to each other. Furthermore, the magnitude of the first vector BC1 and the magnitude of the second vector BC2 may be equal to each other, and the orientation of the first vector BC1 and the orientation of the second vector BC2 may be different from each other. Moreover, the magnitude of the first vector BC1 and the magnitude of the second vector BC2 may be different from each other, and the orientation of the first vector BC1 and the orientation of the second vector BC2 may be the same. The same applies to the first vector BC1 and the fifth vector BC5. Moreover, the same applies to the third vector BC3, the fourth vector BC4, and the sixth vector BC6.

In the above embodiment, the first-end columnar wire 41A and the second-end columnar wire 42B do not have to overlap in the direction extending along the second axis Y.

In the above embodiment, the imaginary line segment L connecting the geometric center OP of the first-end columnar wire 41A and the geometric center OP of the second-end columnar wire 41B may be parallel to the first axis X or the second axis Y.

In the above embodiment, the geometric centers CL1, CL2, and CL3 of the three second end pads 31C, 32C, and 33C may be located on the same line.

In the above embodiment, the three first end electrodes 61A, 62A, and 63A do not have to be arranged parallel to the first axis X. Moreover, the three first end electrodes 61A, 62A, and 63A do not have to be arranged at an equal pitch.

In the above embodiment, when viewed transparently in the direction orthogonal to the first principal surface 20A, the columnar wires 40 may all have the same shape. Furthermore, when viewed transparently in the direction orthogonal to the first principal surface 20A, the columnar wires 40 may all have the same size.

In the above embodiment, the vias 50 are omittable from the inductor component 10. If the vias 50 are to be omitted, the columnar wires 40 and the inductor wires 30 may be directly connected to each other.

In the above embodiment, the insulation layer 70 is omittable from the inductor component 10.

Technical ideas derived from the above embodiment and the modifications are as follows.

[1] An inductor component comprising: an element body having a principal surface; an inductor wire extending parallel to the principal surface within the element body; and a plurality of columnar wires connected to an end of the inductor wire and extending in a direction intersecting the principal surface, wherein the plurality of columnar wires are exposed from the element body at the principal surface, and wherein a minimum distance from the principal surface to the inductor wire is larger than or equal to 0.04 mm.

[2] The inductor component according to [1], wherein, when the principal surface is defined as a first principal surface and a surface of the element body opposite the first principal surface is defined as a second principal surface, the minimum distance from the first principal surface to the inductor wire is larger than or equal to twice a minimum distance from the second principal surface to the inductor wire.

[3] The inductor component according to [1] or [2], wherein, when viewed transparently from a direction orthogonal to the principal surface, the inductor wire extends spirally in a single plane that is parallel to the principal surface.

[4] The inductor component according to any one of [1] to [3], further comprising an outer electrode connected to the columnar wires and exposed from the principal surface, wherein a maximum dimension, in a direction orthogonal to the principal surface, of a portion of the outer electrode provided on the principal surface is smaller than or equal to ½ of a maximum dimension of the inductor wire in the direction orthogonal to the principal surface.

[5] The inductor component according to any one of [1] to [4], wherein, when viewed transparently in a direction orthogonal to the principal surface, the inductor wire extends spirally, and wherein a minimum distance between wire segments of the same inductor wire is larger than or equal to ⅓ of a minimum wire width of the inductor wire.

[6] The inductor component according to any one of [1] to [5], wherein a maximum dimension of each columnar wire in a direction orthogonal to the principal surface is larger than or equal to 1.5 times a maximum dimension of the inductor wire in the direction orthogonal to the principal surface.

[7] The inductor component according to any one of [1] to [6], wherein, when the element body is viewed transparently in a direction orthogonal to the principal surface, the principal surface is quadrilateral. The plurality of columnar wires include a first-end columnar wire connected to a first end of the inductor wire and a second-end columnar wire connected to a second end of the inductor wire. When the element body is viewed transparently in the direction orthogonal to the principal surface, a line segment connecting a geometric center of a surface of the first-end columnar wire exposed from the principal surface and a geometric center of a surface of the second-end columnar wire exposed from the principal surface is not parallel to any of sides of the principal surface.

[8] The inductor component according to any one of [1] to [7], further comprising a plurality of outer electrodes connected to the columnar wires and exposed from the principal surface, wherein, when viewed from a direction orthogonal to the principal surface, the plurality of outer electrodes have an identical shape and an identical area.

[9] The inductor component according to any one of [1] to [8], wherein a maximum dimension of the element body in a direction orthogonal to the principal surface is smaller than or equal to 0.15 mm.

[10] The inductor component according to any one of [1] to [9], wherein the inductor wire includes a first inductor wire extending parallel to the principal surface and a second inductor wire extending in a same plane as the first inductor wire. The plurality of columnar wires include a plurality of first columnar wires connected to an end of the first inductor wire and a plurality of second columnar wires connected to an end of the second inductor wire.

[11] The inductor component according to [10], further comprising a plurality of outer electrodes connected to the columnar wires and exposed from the principal surface. The plurality of outer electrodes include a plurality of first outer electrodes connected to the plurality of first columnar wires and a plurality of second outer electrodes connected to the plurality of second columnar wires. When viewed transparently in a direction orthogonal to the principal surface, the first inductor wire has a portion overlapping at least one selected from the plurality of second outer electrodes.

[12] The inductor component according to or [11], wherein each inductor wire has a wire body, a first end pad connected to a first end of the wire body and having a large wire width relative to the wire body, and a second end pad connected to a second end of the wire body and having a large wire width relative to the wire body, and wherein, when viewed transparently in a direction orthogonal to the principal surface, at least one selected from a size and a shape of the second end pad of the first inductor wire is different from at least one selected from a size and a shape of the second end pad of the second inductor wire.

[13] The inductor component according to any one of to [12], further comprising a plurality of outer electrodes connected to the columnar wires and exposed from the principal surface. The plurality of outer electrodes include a plurality of first outer electrodes connected to the plurality of first columnar wires and a plurality of second outer electrodes connected to the plurality of second columnar wires. When viewed transparently in a direction orthogonal to the principal surface, a geometric center of a surface that belongs to at least one selected from the plurality of first columnar wires and that is exposed from the principal surface is out of alignment with a geometric center of the first outer electrode connected to the first columnar wire, and a geometric center of a surface that belongs to at least one selected from the plurality of second columnar wires and that is exposed from the principal surface is out of alignment with a geometric center of the second outer electrode connected to the second columnar wire. A first vector and a second vector are different from each other, the first vector being a vector extending from the geometric center of the surface that belongs to the at least one selected from the plurality of first columnar wires and that is exposed from the principal surface toward the geometric center of the first outer electrode connected to the first columnar wire, the second vector being a vector extending from the geometric center of the surface that belongs to the at least one selected from the plurality of second columnar wires and that is exposed from the principal surface toward the geometric center of the second outer electrode connected to the second columnar wire.

[14] The inductor component according to any one of to [13], further comprising a plurality of outer electrodes connected to the columnar wires and exposed from the principal surface. The plurality of outer electrodes include a plurality of first outer electrodes connected to the plurality of first columnar wires. Also, of the plurality of first columnar wires, the first columnar wire connected to a first end of the first inductor wire is defined as a first-end columnar wire and the first columnar wire connected to a second end of the first inductor wire is defined as a second-end columnar wire, wherein, when viewed transparently in a direction orthogonal to the principal surface, a geometric center of a surface belonging to the first-end columnar wire and exposed from the principal surface is out of alignment with a geometric center of the first outer electrode connected to the first-end columnar wire, and a geometric center of a surface belonging to the second-end columnar wire and exposed from the principal surface is out of alignment with a geometric center of the first outer electrode connected to the second-end columnar wire. A first vector and a third vector are different from each other, the first vector being a vector extending from the geometric center of the surface belonging to the first-end columnar wire and exposed from the principal surface toward the geometric center of the first outer electrode connected to the first-end columnar wire, the third vector being a vector extending from the geometric center of the surface belonging to the second-end columnar wire and exposed from the principal surface toward the geometric center of the first outer electrode connected to the second-end columnar wire.

[15] The inductor component according to any one of to [14], wherein, when viewed transparently in a direction orthogonal to the principal surface, the inductor wires all extend spirally, and the inductor wires each have 1.5 turns or more.

What is claimed is:

1. An inductor component comprising:
an element body having a principal surface;
an inductor wire extending parallel to the principal surface within the element body; and
a plurality of columnar wires connected to an end of the inductor wire and extending in a direction intersecting the principal surface,
wherein
the plurality of columnar wires are exposed from the element body at the principal surface, and
a minimum distance from the principal surface to the inductor wire is larger than or equal to 0.04 mm.

2. The inductor component according to claim 1, wherein
when the principal surface is defined as a first principal surface and a surface of the element body opposite the first principal surface is defined as a second principal surface, the minimum distance from the first principal surface to the inductor wire is larger than or equal to twice a minimum distance from the second principal surface to the inductor wire.

3. The inductor component according to claim 1, wherein
when viewed transparently from a direction orthogonal to the principal surface, the inductor wire extends spirally in a single plane that is parallel to the principal surface.

4. The inductor component according to claim 1, further comprising:
an outer electrode connected to the columnar wires and exposed from the principal surface,
wherein a maximum dimension, in a direction orthogonal to the principal surface, of a portion of the outer electrode provided on the principal surface is smaller than or equal to ½ of a maximum dimension of the inductor wire in the direction orthogonal to the principal surface.

5. The inductor component according to claim 1, wherein
when viewed transparently in a direction orthogonal to the principal surface, the inductor wire extends spirally, and
a minimum distance between wire segments of the same inductor wire is larger than or equal to ⅓ of a minimum wire width of the inductor wire.

6. The inductor component according to claim 1, wherein
a maximum dimension of each columnar wire in a direction orthogonal to the principal surface is larger than or equal to 1.5 times a maximum dimension of the inductor wire in the direction orthogonal to the principal surface.

7. The inductor component according to claim 1, wherein
when the element body is viewed transparently in a direction orthogonal to the principal surface, the principal surface is quadrilateral,
the plurality of columnar wires include a first-end columnar wire connected to a first end of the inductor wire and a second-end columnar wire connected to a second end of the inductor wire, and
when the element body is viewed transparently in the direction orthogonal to the principal surface, a line segment connecting a geometric center of a surface of the first-end columnar wire exposed from the principal surface and a geometric center of a surface of the second-end columnar wire exposed from the principal surface is not parallel to any of sides of the principal surface.

8. The inductor component according to claim 1, further comprising:
a plurality of outer electrodes connected to the columnar wires and exposed from the principal surface,
when viewed from a direction orthogonal to the principal surface, the plurality of outer electrodes have an identical shape and an identical area.

9. The inductor component according to claim 1, wherein
a maximum dimension of the element body in a direction orthogonal to the principal surface is smaller than or equal to 0.15 mm.

10. The inductor component according to claim 1, wherein
the inductor wire includes a first inductor wire extending parallel to the principal surface and a second inductor wire extending in a same plane as the first inductor wire, and
the plurality of columnar wires include a plurality of first columnar wires connected to an end of the first inductor wire and a plurality of second columnar wires connected to an end of the second inductor wire.

11. The inductor component according to claim 10, further comprising:
a plurality of outer electrodes connected to the columnar wires and exposed from the principal surface,
wherein
the plurality of outer electrodes include a plurality of first outer electrodes connected to the plurality of first columnar wires and a plurality of second outer electrodes connected to the plurality of second columnar wires, and
when viewed transparently in a direction orthogonal to the principal surface, the first inductor wire has a portion overlapping at least one selected from the plurality of second outer electrodes.

12. The inductor component according to claim 10, wherein
each inductor wire has a wire body, a first end pad connected to a first end of the wire body and having a large wire width relative to the wire body, and a second end pad connected to a second end of the wire body and having a large wire width relative to the wire body, and
when viewed transparently in a direction orthogonal to the principal surface, at least one selected from a size and a shape of the second end pad of the first inductor wire is different from at least one selected from a size and a shape of the second end pad of the second inductor wire.

13. The inductor component according to claim 10, further comprising:
a plurality of outer electrodes connected to the columnar wires and exposed from the principal surface,
wherein
the plurality of outer electrodes include a plurality of first outer electrodes connected to the plurality of first columnar wires and a plurality of second outer electrodes connected to the plurality of second columnar wires,
when viewed transparently in a direction orthogonal to the principal surface, a geometric center of a surface that belongs to at least one selected from the plurality of first columnar wires and that is exposed from the principal surface is out of alignment with a geometric center of the first outer electrode connected to the first columnar wire, and a geometric center of a surface that belongs to at least one selected from the plurality of second columnar wires and that is exposed from the principal surface is out of alignment with a geometric center of the second outer electrode connected to the second columnar wire, and
a first vector and a second vector are different from each other, the first vector being a vector extending from the geometric center of the surface that belongs to the at least one selected from the plurality of first columnar wires and that is exposed from the principal surface toward the geometric center of the first outer electrode connected to the first columnar wire, the second vector being a vector extending from the geometric center of the surface that belongs to the at least one selected from the plurality of second columnar wires and that is exposed from the principal surface toward the geometric center of the second outer electrode connected to the second columnar wire.

14. The inductor component according to claim 10, further comprising:
a plurality of outer electrodes connected to the columnar wires and exposed from the principal surface,
wherein
the plurality of outer electrodes include a plurality of first outer electrodes connected to the plurality of first columnar wires,
of the plurality of first columnar wires, the first columnar wire connected to a first end of the first inductor wire is defined as a first-end columnar wire and the first columnar wire connected to a second end of the first inductor wire is defined as a second-end columnar wire,
when viewed transparently in a direction orthogonal to the principal surface, a geometric center of a surface belonging to the first-end columnar wire and exposed from the principal surface is out of alignment with a geometric center of the first outer electrode connected to the first-end columnar wire, and a geometric center of a surface belonging to the second-end columnar wire and exposed from the principal surface is out of alignment with a geometric center of the first outer electrode connected to the second-end columnar wire, and
a first vector and a third vector are different from each other, the first vector being a vector extending from the geometric center of the surface belonging to the first-end columnar wire and exposed from the principal surface toward the geometric center of the first outer electrode connected to the first-end columnar wire, the third vector being a vector extending from the geometric center of the surface belonging to the second-end columnar wire and exposed from the principal surface toward the geometric center of the first outer electrode connected to the second-end columnar wire.

15. The inductor component according to claim 10, wherein
when viewed transparently in a direction orthogonal to the principal surface, the inductor wires all extend spirally, and the inductor wires each have 1.5 turns or more.
